(19) United States
(12) Patent Application Publication
(10) Pub. No.: US 2020/0349509 A1
(43) Pub. Date: Nov. 5, 2020

(54) DETERMINING AN OPTIMAL ROUTE FOR LOGISTICS DELIVERY

(71) Applicant: Accenture Global Solutions Limited, Dublin (IE)

(72) Inventors: Deepak A. Sharma, Bengaluru (IN); Romesh Viswanath, Hyderabad (IN); Ram Mohen Mohen Venkatakrishnan, Bengaluru (IN); Trinadh Babu Kunapureddy, Hyderabad (IN); Karthik Srinivasan, Tamilnadu (IN)

(21) Appl. No.: 16/510,412

(22) Filed: Jul. 12, 2019

Related U.S. Application Data
(63) Continuation-in-part of application No. 16/400,797, filed on May 1, 2019.

(51) Int. Cl. G06Q 10/08; G06Q 10/04; G01C 21/34; G06N 10/00

(52) U.S. Cl. CPC G06Q 10/08355; G06N 10/00; G01C 21/343; G06Q 10/047

(57) ABSTRACT

A device may receive first information relating to a plurality of locations and second information relating to one or more preferences for determining a route order for the plurality of locations. The device may identify one or more parameters for determining the route order for the plurality of locations. The device may generate a quantum model based on the first information, the second information, and the one or more parameters. The device may determine, using a quantum solver, one or more minimum energy states of the quantum model. The one or more minimum energy states may correspond to respective candidate route orders for the plurality of locations. The device may determine, based on a candidate route order corresponding to a minimum energy state of the one or more minimum energy states, a route between the plurality of locations.

### RELATED APPLICATION

This application is a CONTINUATION-IN-PART (CIP) of U.S. patent application Ser. No. 16/400,797 (“CELL RESOURCE ALLOCATION”), filed on May 1, 2019, the content of which is incorporated by reference herein in its entirety.

### BACKGROUND

Delivery logistics concerns the physical process of transporting cargo (e.g., a good, a package, and/or the like). For example, one or more vehicles may be assigned a route that may be traversed to deliver cargo to multiple locations.

### SUMMARY

According to some implementations, a method may include receiving, by a device, first information relating to a plurality of locations and second information relating to one or more preferences for determining a route order for the plurality of locations, wherein the first information includes distances between the plurality of locations, and wherein the second information relates to respective priorities for the one or more preferences; identifying, by the device, one or more parameters for determining the route order for the plurality of locations; generating, by the device, a quantum model based on the first information, the second information, and the one or more parameters; determining, by the device and using a quantum solver, one or more minimum energy states of the quantum model, wherein the one or more minimum energy states correspond to respective candidate route orders for the plurality of locations; and determining, by the device and based on a candidate route order corresponding to a minimum energy state of the one or more minimum energy states, a route between the plurality of locations.

According to some implementations, a device may include one or more memories and one or more processors to receive first information relating to a plurality of locations and second information relating to one or more preferences for determining a route order for the plurality of locations, wherein the first information relates to distances between the plurality of locations, travel times between the plurality of locations, or respective valuations associated with the plurality of locations, wherein the second information relates to respective priorities for the one or more preferences, and wherein the one or more preferences relate to maximizing a valuation associated with the route order, minimizing a distance associated with the route order, minimizing a travel time associated with the route order, or minimizing a cost associated with the route order; identify one or more parameters for determining the route order for the plurality of locations; generate a quantum model based on the first information, the second information, and the one or more parameters; determine, using a quantum solver, a minimum energy state of the quantum model, wherein the minimum energy state corresponds to a candidate route order for the plurality of locations; and determine, based on the candidate route order, a route between the plurality of locations.

According to some implementations, a non-transitory computer-readable medium may store one or more instructions that, when executed by one or more processors, may cause the one or more processors to determine a representation of a plurality of locations based on information relating to the plurality of locations; identify respective priorities for one or more preferences for determining a route order for the plurality of locations and one or more parameters for determining the route order for the plurality of locations; generate a quantum model based on the representation, the one or more preferences, and the one or more parameters; determine, using a quantum solver, one or more minimum energy states of the quantum model, wherein the one or more minimum energy states correspond to respective candidate route orders for the plurality of locations; and identify, based on a candidate route order corresponding to a minimum energy state of the one or more minimum energy states, a route between the plurality of locations.

### BRIEF DESCRIPTION OF THE DRAWINGS

FIGS. 1A-1E are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flowcharts of example processes for determining a route order for locations.

### DETAILED DESCRIPTION

The following detailed description of example implementations refers to the accompanying drawings. The same reference numbers in different drawings may identify the same or similar elements.

Vehicles may be used to transport cargo (e.g., one or more goods, one or more packages, one or more products, and/or the like) via air, via land, via sea, and/or the like. For example, a vehicle may be used to transport cargo to various destinations across a geographic area. In such a case, a logistics enterprise (e.g., a freight enterprise, a courier enterprise, a ride-sharing enterprise, and/or the like) associated with the vehicle may attempt to determine an optimal route between multiple delivery locations that the vehicle is to visit.

Current techniques may permit the logistics enterprise to determine (e.g., using a computing device) a shortest route between the multiple delivery locations. However, in some cases the logistics enterprise may desire a route other than a shortest route, or desire a route that accounts for distance as well as other factors. For example, the logistics enterprise may desire a route that minimizes a distance, a time, and/or a cost associated with the route and/or maximizes a delivery value associated with the route. Moreover, the logistics enterprise may have one or more preferences relating to distance, time, cost, and/or delivery value associated with the route. For example, the logistics enterprise may assign a higher priority to minimizing cost associated with the route and assign a lower priority to maximizing delivery value associated with the route. Determining a route between dozens or hundreds of delivery locations according to such preferences is technically complex, and when performed on computing devices according to current techniques, may expend significant computing resources, may cause freezing or crashing of the computing devices, and/or the like.

According to some implementations described herein, a route platform may facilitate efficient determination of a route between a plurality of locations. In some implementations, the route platform may receive location information relating to a plurality of locations and preference information relating to one or more preferences for determining a route order for the plurality of locations. For example, the location information may relate to distances between the plurality of locations, times between the plurality of locations, respective valuations associated with the plurality of locations, and/or the like, and the preference information may relate to respective priorities for the one or more preferences, which may relate to maximizing a valuation associated with the route order, minimizing a distance associated with the route order, minimizing a time associated with the route order, minimizing a cost associated with the route order, and/or the like.

In some implementations, the route platform may identify one or more parameters for determining the route order for the plurality of locations. For example, the one or more parameters may include a parameter specifying that each location, of the plurality of locations, is to be included in the route order only once, a parameter specifying that each location, of the plurality of locations, is to be included in the route order, and/or the like. The route platform may generate a quantum model based on the location information, the preference information, and the one or more parameters, and determine, using a quantum solver, a minimum energy state of the quantum model. In such a case, the minimum energy state may correspond to a candidate route order for the plurality of locations. Moreover, the route platform may determine, based on the candidate route order, a route between the plurality of locations and generate, for display in a user interface, a visualization of the route between the plurality of locations.

In this way, the route platform provides fast and efficient route determination between numerous locations (e.g., dozens or hundreds of delivery locations). Moreover, relative to current techniques, the route platform is able to determine a route between numerous locations according to one or more preferences in a manner that conserves computing resources and reduces or eliminates computer crashes. Furthermore, the route platform provides optimized delivery routes that allow logistics enterprises to conserve delivery resources, to allocate delivery resources efficiently, to reduce delivery delays, and/or the like.

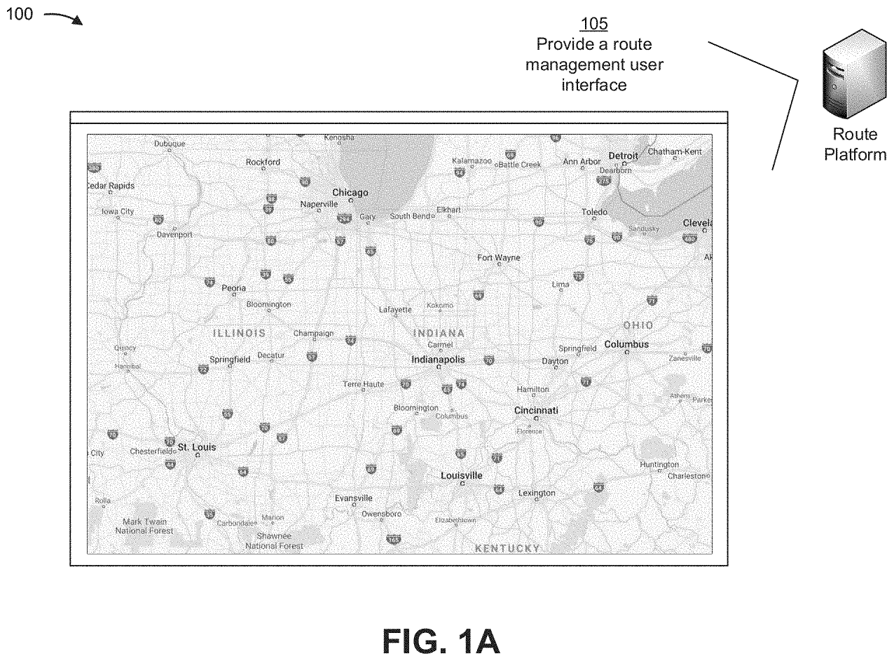

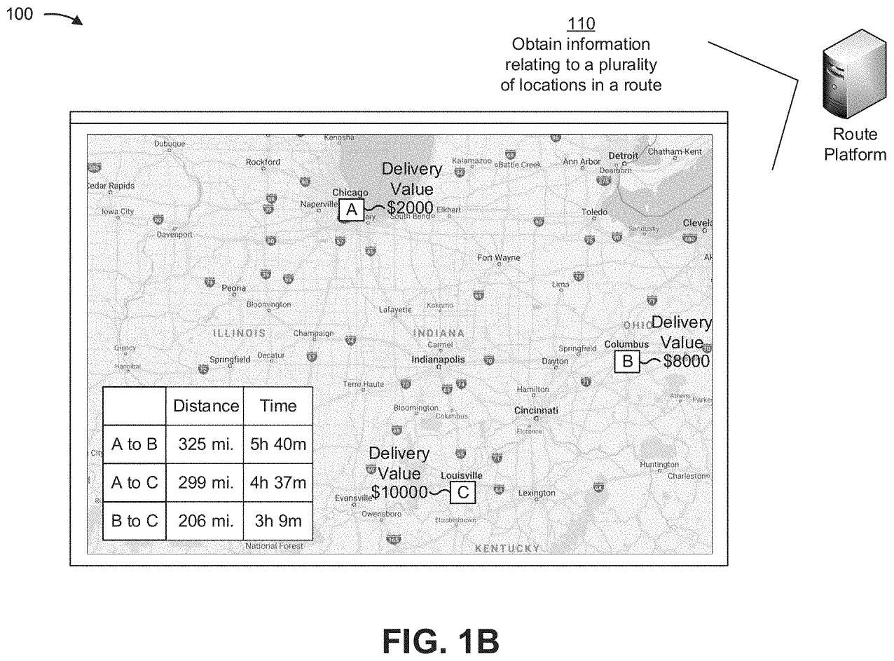

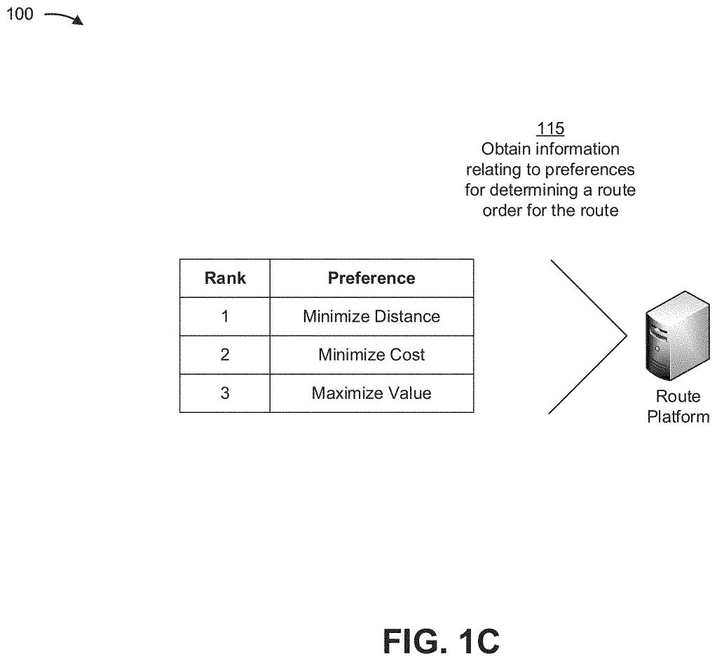

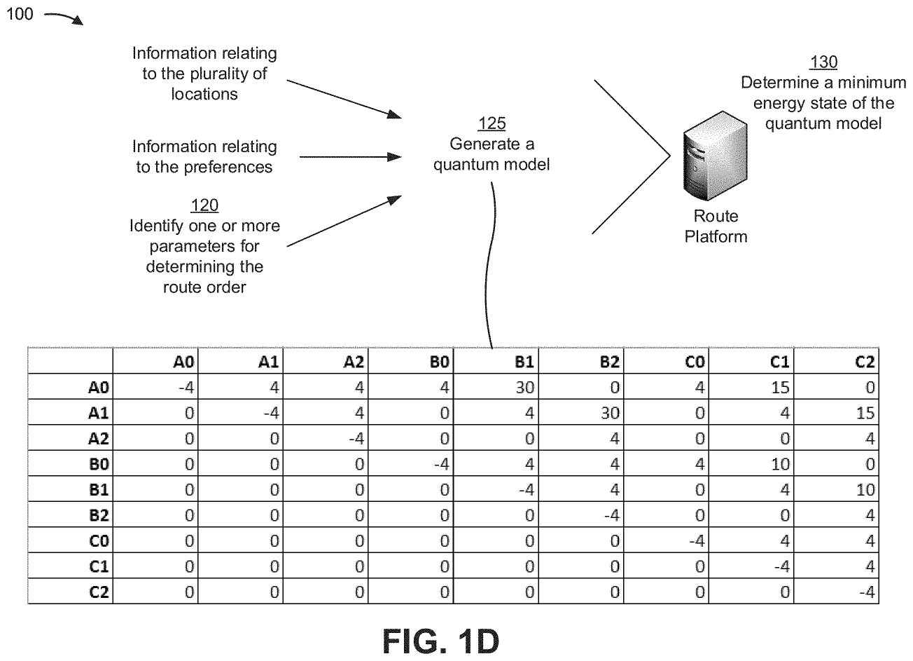

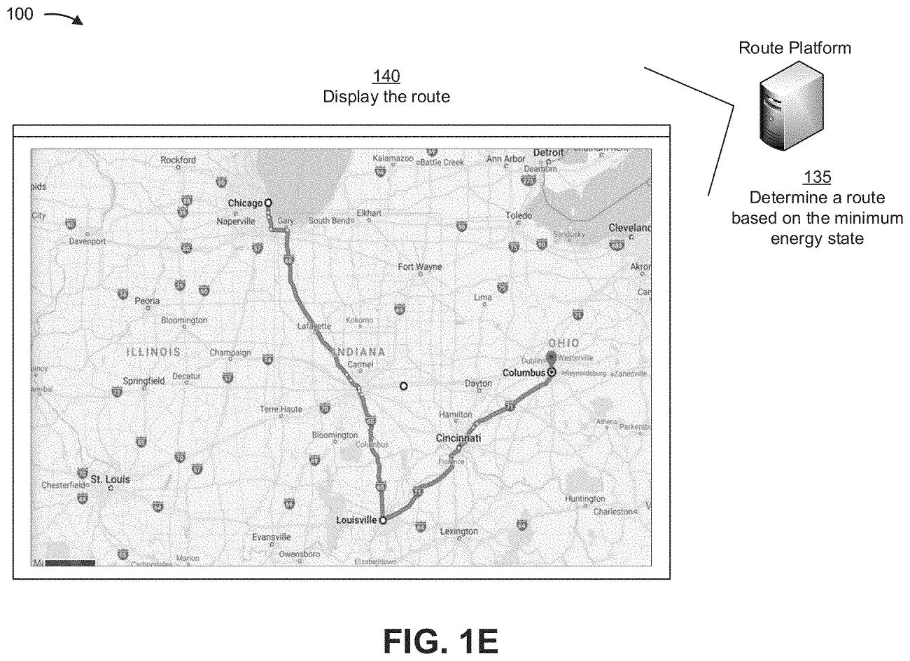

FIGS. 1A-1E are diagrams of one or more example implementations 100 described herein. As shown in FIGS. 1A-1E, example implementation(s) 100 may include a route platform. The route platform may be a computing device, a server, a cloud computing device, and/or the like that processes information relating to locations, preferences for determining a route order, parameters for determining the route order, and/or the like to determine a route order for a plurality of locations. The route platform may be associated with a logistics enterprise, such as a freight enterprise, a carrier enterprise (e.g., an airline), a courier enterprise, a ride-sharing enterprise, and/or the like. A logistics enterprise may be involved in delivery of cargo, such as goods, produce, packages, products, and/or the like, or may be involved in transporting people. As used herein, the term “delivery” may refer to delivery of cargo or transportation of people. A logistics enterprise may be associated with one or more vehicles (e.g., cars, trucks, watercraft, aircraft, bicycles, and/or the like) that are used in the delivery of cargo.

As shown in FIG. 1A, and by reference number 105, the route platform may provide a route management user interface, which may be used to identify a plurality of locations (e.g., delivery locations), identify information relating to the plurality of locations, identify one or more preferences, visualize a route (e.g., a delivery route) associated with the plurality of locations, and/or the like. The route management user interface may include a graphical user interface in which a map may be displayed along with an overlay of locations. The map may include a navigation map, a satellite image map, a topological map, and/or the like. Moreover, the route management user interface may include one or more input elements that permit users to provide information and/or instructions for the route platform. For example, the one or more input elements may permit a user to identify one or more locations (e.g., by clicking on a map, by entering an address, by entering coordinates, and/or the like), identify information relating to the one or more locations (e.g., by entering the information), identify one or more preferences (e.g., by entering the one or more preferences, by selecting the one or more preferences, and/or the like), and/or the like.

In some implementations, a user (e.g., using the route management user interface) may identify a plurality of locations for which the route platform is to determine a route (e.g., a route order). Additionally, or alternatively, the route platform may automatically identify a plurality of locations for which the route platform is to determine a route (e.g., a route order). For example, the route platform may automatically identify the plurality of locations based on orders received by the logistics enterprise, delivery tasks received by the logistics enterprise, bills of lading issued by the logistics enterprise, and/or the like.

The plurality of locations may be associated with respective coordinates (e.g., latitude and longitude coordinates). Accordingly, the route platform (e.g., according to the map of the route management user interface) may obtain respective coordinates for the plurality of locations. In some implementations, the route platform may map coordinates of a location to an identifier for the location. For example, the route platform may map coordinates associated with a location in Chicago (e.g., 41.8339042, −88.0121522) to an identifier for the location in Chicago (e.g., location “A”), may map coordinates associated with a location in Columbus (e.g., 39.9831302, −83.1309142) to an identifier for the location in Columbus (e.g., location “B”), and/or the like.

As shown in FIG. 1B, and by reference number 110, the route platform may obtain information relating to the plurality of locations. The information relating to the plurality of locations may include a distance (e.g., a shortest distance according to a particular mode of travel) and/or a travel time (e.g., a shortest travel time according to a particular mode of travel) between any one location of the plurality of locations and any other location of the plurality of locations. In other words, the information relating to the plurality of locations may include a distance and/or a travel time between every possible two-location combination among the plurality of locations. For example, if there are first, second, and third locations included in the plurality of locations, the route platform may obtain information relating to a distance and/or a travel time between the first location and the second location, between the first location and the third location, and between the second location and the third location.

In some implementations, the route platform may determine distances and/or travel times between the plurality of locations using a shortest path solver. In some implementations, the route platform may provide respective coordinates for the plurality of locations to the shortest path solver via an API (e.g., a representational state transfer (REST) API and/or another type of API).

The route platform may provide respective coordinates for the plurality of locations to the shortest path solver, which may determine distances and/or travel times between the plurality of locations based on the coordinates. For example, if the mode of travel used by the logistics enterprise is by car or truck, the shortest path solver may determine distances and/or travel times between the plurality of locations according to existing roads. In such a case, a distance may relate to a shortest path between any one location and any other location using existing roads, and a travel time may relate to a travel time associated with the shortest path according to existing or anticipated roadway conditions, traffic, speed limits, and/or the like.

In some implementations, the information relating to the plurality of locations may include respective valuations for the plurality of locations. In some cases, a user (e.g., using the route management user interface) may identify respective valuations for the plurality of locations. Additionally, or alternatively, the route platform may automatically identify respective valuations for the plurality of locations (e.g., based on orders received by the logistics enterprise, delivery tasks received by the logistics enterprise, bills of lading issued by the logistics enterprise, and/or the like). Additionally, or alternatively, the route platform may receive valuation data relating to products that are to be delivered to the plurality of locations, and identify respective valuations for the plurality of locations based on the valuation data and information relating to respective sets of products that are to be delivered to the plurality of locations. A valuation for a location may relate to a cost of cargo (e.g., a cost of the cargo to the logistics enterprise or another owner of the cargo) that is to be delivered to the location, a value of cargo (e.g., a market value of the cargo) that is to be delivered to the location, earnings associated with delivering cargo to the location (e.g., revenue that the logistics enterprise has earned, or will earn, for delivering the cargo to the location), and/or the like.

In some implementations, the route platform may determine a representation of the plurality of locations based on the information relating to the plurality of locations. For example, the route platform may generate a matrix that represents distances and/or travel times between the plurality of locations and/or respective valuations for the plurality of locations. Additionally, or alternatively, the route platform may generate a graph that represents distances and/or travel times between the plurality of locations and/or respective valuations for the plurality of locations. For example, the route platform may generate a graph for the plurality of locations that may represent a model of the plurality of locations. Vertices (or nodes) of the graph may represent respective locations of the plurality of locations. Edges of the graph may represent a distance and/or a travel time between locations and/or a valuation associated with visiting a location.

As shown in FIG. 1C, and by reference number 115, the route platform may obtain information relating to one or more preferences for determining a route (e.g., a route order) for the plurality of locations. In some cases, a user (e.g., using the route management user interface) may identify the information relating to the one or more preferences. The one or more preferences may relate to maximizing valuation (e.g., delivering to locations associated with higher valuations before locations with lower valuations), minimizing distance, minimizing travel time, and/or minimizing cost (e.g., costs associated with fuel, driver wages, vehicle wear and tear, and/or the like) associated with a route (e.g., a route order) for the plurality of locations.

The information relating to the one or more preferences may include respective priorities for the one or more preferences. For example, the information may include respective priorities associated with maximizing valuation, minimizing distance, minimizing travel time, and/or minimizing cost. The respective priorities may be chosen by the logistics enterprise according to particular objectives desired by the logistics enterprise.

In some implementations, the respective priorities may assign rankings to the one or more preferences. For example, the respective priorities may identify a first of the preferences (e.g., maximizing valuation, minimizing distance, minimizing travel time, or minimizing cost) as a highest priority, a second of the preferences as a second-highest priority, and so forth. Additionally, or alternatively, the respective priorities may assign respective scores to the one or more preferences. A score may represent an importance of a preference. For example, a first of the preferences (e.g., maximizing valuation, minimizing distance, minimizing travel time, or minimizing cost) may be assigned a first score (e.g., 5 out of 10), a second of the preferences may be assigned a second score (e.g., 9 out of 10), and so forth.

As shown in FIG. 1D, and by reference number 120, the route platform may identify one or more parameters for determining a route (e.g., a route order) for the plurality of locations. The one or more parameters may be configurable according to a manner in which a route (e.g., a route order) is to be determined. In some implementations, the one or more parameters may include a parameter specifying that each location, of the plurality of locations, is to be included in the route order only once, a parameter specifying that each location, of the plurality of locations, is to be included in the route order, and/or the like.

As shown by reference number 125, the route platform may generate a quantum model. For example, the route platform may generate a quantum model based on the information relating to the plurality of locations, the information relating to the one or more preferences, and/or the one or more parameters.

In some implementations, the route platform may generate the quantum model as a matrix that may include a plurality of columns and rows that represent the plurality of locations. For example, in the example matrix shown by reference number 125, A, B, and C represent locations (e.g., Chicago, Columbus, and Louisville, respectively, as shown in FIG. 1B) and 0, 1, and 2 represent a position of a location in a route order. An element of the matrix may represent travelling between two locations of the plurality of locations. For example, in the example matrix shown by reference number 125, the element at an intersection of A0 and B1 represents a route order in which location A is visited first and location B is visited second. To generate the matrix, the route platform may generate a quadratic unconstrained binary optimization (QUBO) problem based on the information relating to the plurality of locations (e.g., based on the representation of the plurality of locations) and may convert the QUBO problem to the matrix. Since the QUBO is an unconstrained problem, the route platform may apply one or more constraints to the QUBO problem to obtain a constrained QUBO problem. The one or more constraints may be based on the information relating to the one or more preferences and/or the one or more parameters.

For example, a parameter specifying that each location, of the plurality of locations, is to be included in the route order only once may be represented by Equation 1:

$$g * {\sum }_{c = 1 - n} {( 1 - {\sum }_{j = 1 - N} {x}_{c , j} )}^{2} \qquad Equation 1$$

where g represents a Lagrange multiplier that identifies whether values are to be maximized or minimized, c represents a location of the plurality of locations, n represents a quantity of locations of the plurality of locations, j represents a position of the location in a route order, N represents a quantity of positions in the route order, and x_{c,j} represents the location c at position j in the route order.

As another example, a parameter specifying that each location, of the plurality of locations, is to be included in the route order may be represented by Equation 2:

$$g * {\sum }_{j = 1 - N} {( 1 - {\sum }_{c = 1 - n} {x}_{c , j} )}^{2} \qquad Equation 2$$

where g represents a Lagrange multiplier that identifies whether values are to be maximized or minimized, c represents a location of the plurality of locations, n represents a quantity of locations of the plurality of locations, j represents a position of the location in a route order, N represents a quantity of positions in the route order, and x_{c,j} represents the location c at position j in the route order.

As a further example, priorities for preferences relating to maximizing valuation, minimizing time, and minimizing distance may be represented by Equation 3:

$$g * ( {p}_{3} * {\sum }_{( bc ) IN ( distance edges )} {Distance}_{bc} * {\sum }_{j = 1 - N} {x}_{b , j} {x}_{c , j + 1} + {p}_{2} * {\sum }_{( bc ) IN ( time edges )} {Time}_{bc} * {\sum }_{j = 1 - N} {x}_{b , j} {x}_{c , j + 1} - {p}_{1} * {\sum }_{b = valuation} {Valuation}_{b} * {\sum }_{c = valuation} {Valuation}_{c} * {\sum }_{j = 1 - N} {x}_{b , j} {x}_{c , j + 1} ) \qquad Equation 3$$

where g represents a Lagrange multiplier that identifies whether values are to be maximized or minimized, j represents a position of a location in a route order, N represents a quantity of positions in the route order, p₁, p₂, and p₃ represent weightings according to respective priorities assigned to maximizing valuation, minimizing time, and minimizing distance, b and c represent respective locations of the plurality of locations, x_{b,j} represents the location b at position j in the route order, x_{c,j+1} represents the location c at position j+1 in the route order, Distance_{bc} represents a distance between location b and location c, Time_{bc} represents a travel time between location b and location c, Valuation_{b} represents a valuation associated with location b, and Valuation_{c} represents a valuation associated with location c.

In some implementations, the route platform may determine the constrained QUBO problem as a sum of Equation 1, Equation 2, and Equation 3. The route platform may generate the quantum model by converting the constrained QUBO problem to a matrix. In some implementations, the quantum model may be the constrained QUBO problem without converting the constrained QUBO problem to a matrix.

As shown by reference number 130, the route platform may determine a minimum energy state of the quantum model. Since a quantity of locations that may be modeled potentially includes dozens or hundreds of locations, the route platform may provide a quantum computing environment to reduce the processing time for determining one or more route orders for the locations. The quantum computing environment may include a combination of hardware (e.g., one or more quantum processing units (QPUs)) and software (e.g., one or more quantum solvers, one or more quantum samplers, and/or the like) that is capable of generating a plurality of candidate route orders in parallel.

Accordingly, the route platform may provide the quantum model to the quantum computing environment such that the route platform may use the one or more QPUs and the one or more quantum solvers to process the quantum model. In some implementations, the route platform may provide the quantum model to the one or more quantum solvers via an API (e.g., a REST API and/or another type of API).

The route platform may use the one or more QPUs and the one or more quantum solvers to process the quantum model. The output of the one or more quantum solvers may be one or more candidate route orders for the plurality of locations (e.g., an ordered list of the plurality of locations). For example, a candidate route order may be C0, B1, A2 (e.g., in connection with the example matrix shown by reference number 125), which may indicate that location C is to be visited first, location B is to be visited second, and location A is to be visited third according to the candidate route order. A candidate route order may represent a route order that results in a minimum energy state of the quantum model. A minimum energy state of the quantum model may include a candidate route order that results in the lowest value output from the quantum model. In some implementations, the lowest value output from the quantum model may be a zero value or a negative value.

In some implementations, the route platform may select the candidate route order that results in the minimum energy state for the quantum model. In some implementations, if a plurality of candidate route orders result in minimum energy states (e.g., the plurality of candidate route orders each result in a zero output value from the quantum solver), the route platform may select a candidate route order from the plurality of route orders. For example, the route platform may select the candidate route order according to one or more additional preferences of a user or the logistics enterprise. As an example, an additional preference may relate to a preference for a particular delivery to occur first or last, a preference for a particular delivery to occur as soon as possible, and/or the like.

As shown in FIG. 1E, and by reference number 135, the route platform may determine a route based on a candidate route order associated with a minimum energy state, or based on a candidate route order selected from a plurality of candidate route orders associated with minimum energy states. The candidate route order may identify a route order according to respective location identifiers for the plurality of locations. For example, the candidate route order may identify, in order, a first location (e.g., location “B”), a second location (e.g., location “A”), and so forth. Accordingly, before determining the route, the route platform may convert the plurality of locations of the candidate route order to respective coordinates. For example, the route platform may use a mapping of location identifiers to coordinates, as described above, to convert the plurality of locations of the candidate route order to respective coordinates.

Based on the respective coordinates for the plurality of locations, the route platform may determine the route between the plurality of locations according to the candidate route order. For example, the route platform may determine the route using the shortest path solver. In some implementations, the route platform may provide respective coordinates for the plurality of locations to the shortest path solver via an API (e.g., a REST API and/or another type of API).

The route platform may provide, in accordance with the candidate route order, respective coordinates for the plurality of locations to the shortest path solver, which may determine a shortest path between the plurality of locations that follows the candidate route order. For example, if the mode of travel used by the logistics enterprise is by car or truck, the shortest path solver may determine a shortest path between the plurality of locations, that follows the candidate route order, according to existing roads.

As shown by reference number 140, the route platform may display the route that is determined. That is, the route platform may display a visual representation of the route that is determined. The route platform may display the visual representation of the route in the route management user interface. For example, the route platform may display the visual representation of the route as an overlay on a map displayed in the route management user interface. In addition, the route management user interface may visually indicate a route order associated with the route. For example, the route order may be visually indicated by numerical identifiers (e.g., 1, 2, 3, and/or the like) overlaid on the map. Alternatively, the route management user interface may provide an ordered list of a route order associated with the route.

In some implementations, the route platform may provide distance information, travel time information, cost information, and/or valuation information associated with the route. The route platform may determine distance information and/or travel time information using the shortest path solver, as described above. The route platform may determine cost information based on the distance information and/or the travel time information and further based on per mile and/or per hour costs associated with the logistics enterprise (e.g., fuel costs, driver wage costs, wear and tear costs, and/or the like). The route platform may determine valuation information as a cumulative valuation that will be captured or realized at various time points associated with the route (e.g., at each location of the route). The route platform may provide the distance information, travel time information, cost information, and/or valuation information in the route management user interface.

In some implementations, the route platform may determine directions (e.g., turn-by-turn directions) associated with the route. For example, the route platform may determine the directions using the shortest path solver. The route platform may provide the directions in the route management user interface. In some implementations, the route management user interface may further provide buttons and/or other types of input means such that a user may clear or reset the route, modify the route, remove and/or add one or more locations to the plurality of locations, identify user preferences for determining the route (e.g., avoid highways, avoid tolls, and/or the like), and/or the like.

In this way, the route platform provides a route between numerous locations (e.g., dozens or hundreds of locations) that is optimized according to one or more preferences of a logistics enterprise. The route platform facilitates efficient determination of the route with improved speed relative to current techniques. Accordingly, the route platform conserves computing resources, reduces computer crashes, and/or the like relative to current techniques. Moreover, by determining the route according to the one or more preferences of the logistics enterprise, the route platform facilitates conservation of the logistics enterprise's delivery resources and efficient allocation of the logistics enterprise's delivery resources, while improving on-time delivery, reducing delivery delays, reducing delivery costs, and/or the like.

As indicated above, FIGS. 1A-1E are provided merely as one or more examples. Other examples may differ from what is described with regard to FIGS. 1A-1E.

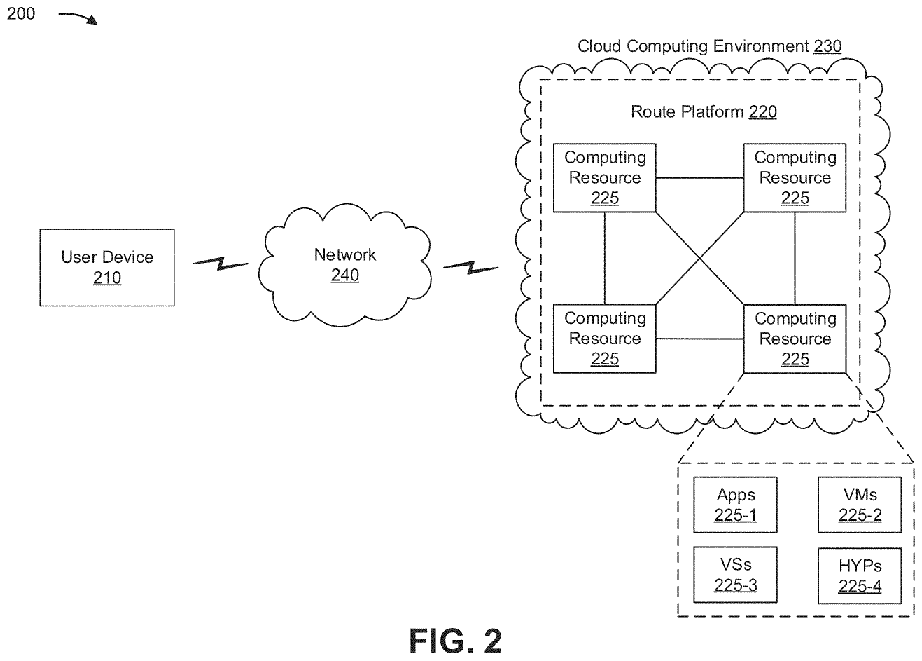

FIG. 2 is a diagram of an example environment 200 in which systems and/or methods described herein may be implemented. As shown in FIG. 2, environment 200 may include a user device 210, a route platform 220, a computing resource 225, a cloud computing environment 230, and a network 240. Devices of environment 200 may interconnect via wired connections, wireless connections, or a combination of wired and wireless connections.

User device 210 includes one or more devices capable of receiving, generating, storing, processing, and/or providing information associated with a plurality of locations for which a route is to be determined, one or more preferences for determining a route, a determined route, and/or the like. For example, user device 210 may include a communication and/or computing device, such as a mobile phone (e.g., a smart phone, a radiotelephone, and/or the like), a laptop computer, a tablet computer, a handheld computer, a gaming device, a wearable communication device (e.g., a smart wristwatch, a pair of smart eyeglasses, and/or the like), or a similar type of device.

Route platform 220 includes one or more computing resources assigned to determine a route between a plurality of locations. For example, route platform 220 may be a platform implemented by cloud computing environment 230 that may obtain information relating to a plurality of locations, obtain information relating to one or more preferences, identify information relating to one or more parameters, generate a quantum model, determine a route order for the plurality of locations, and determine a route based on the route order, and/or the like. In some implementations, route platform 220 is implemented by computing resources 225 of cloud computing environment 230.

Route platform 220 may include a server device or a group of server devices. In some implementations, route platform 220 may be hosted in cloud computing environment 230. Notably, while implementations described herein may describe route platform 220 as being hosted in cloud computing environment 230, in some implementations, route platform 220 may be non-cloud-based or may be partially cloud-based.

Cloud computing environment 230 includes an environment that delivers computing as a service, whereby shared resources, services, and/or the like may be provided to user device 210, or the like. Cloud computing environment 230 may provide computation, software, data access, storage, and/or other services that do not require end-user knowledge of a physical location and configuration of a system and/or a device that delivers the services. As shown, cloud computing environment 230 may include route platform 220 and computing resource 225.

Computing resource 225 includes one or more personal computers, workstation computers, server devices, or another type of computation and/or communication device. In some implementations, computing resource 225 may host route platform 220. The cloud resources may include compute instances executing in computing resource 225, storage devices provided in computing resource 225, data transfer devices provided by computing resource 225, and/or the like. In some implementations, computing resource 225 may communicate with other computing resources 225 via wired connections, wireless connections, or a combination of wired and wireless connections.

As further shown in FIG. 2, computing resource 225 may include a group of cloud resources, such as one or more applications (“APPs”) 225-1, one or more virtual machines (“VMs”) 225-2, virtualized storage (“VSs”) 225-3, one or more hypervisors (“HYPs”) 225-4, or the like.

Application 225-1 includes one or more software applications that may be provided to or accessed by user device 210, or the like. Application 225-1 may eliminate a need to install and execute the software applications on user device 210, or the like. For example, application 225-1 may include software associated with route platform 220 and/or any other software capable of being provided via cloud computing environment 230. In some implementations, one application 225-1 may send/receive information to/from one or more other applications 225-1, via virtual machine 225-2.

Virtual machine 225-2 includes a software implementation of a machine (e.g., a computer) that executes programs like a physical machine. Virtual machine 225-2 may be either a system virtual machine or a process virtual machine, depending upon use and degree of correspondence to any real machine by virtual machine 225-2. A system virtual machine may provide a complete system platform that supports execution of a complete operating system. A process virtual machine may execute a single program and may support a single process. In some implementations, virtual machine 225-2 may execute on behalf of a user, and may manage infrastructure of cloud computing environment 230, such as data management, synchronization, or long-duration data transfers.

Virtualized storage 225-3 includes one or more storage systems and/or one or more devices that use virtualization techniques within the storage systems or devices of computing resource 225. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 225-4 provides hardware virtualization techniques that allow multiple operating systems (e.g., “guest operating systems”) to execute concurrently on a host computer, such as computing resource 225. Hypervisor 225-4 may present a virtual operating platform to the guest operating systems and may manage the execution of the guest operating systems. Multiple instances of a variety of operating systems may share virtualized hardware resources.

Network 240 includes one or more wired and/or wireless networks. For example, network 240 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The quantity and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

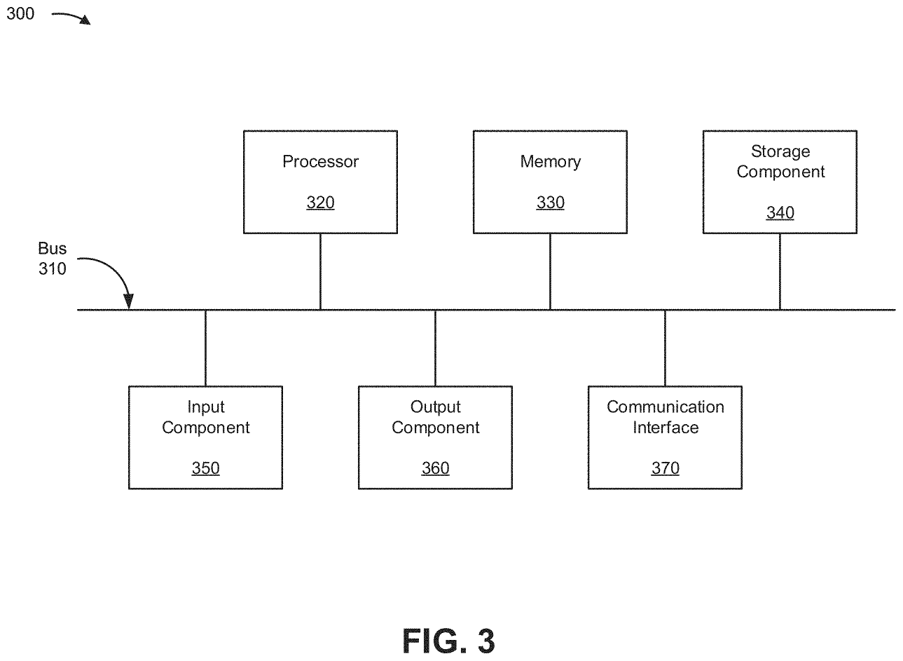

FIG. 3 is a diagram of example components of a device 300. Device 300 may correspond to user device 210, route platform 220, and/or computing resource 225. In some implementations, user device 210, route platform 220, and/or computing resource 225 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among multiple components of device 300. Processor 320 is implemented in hardware, firmware, and/or a combination of hardware and software. Processor 320 takes the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The quantity and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

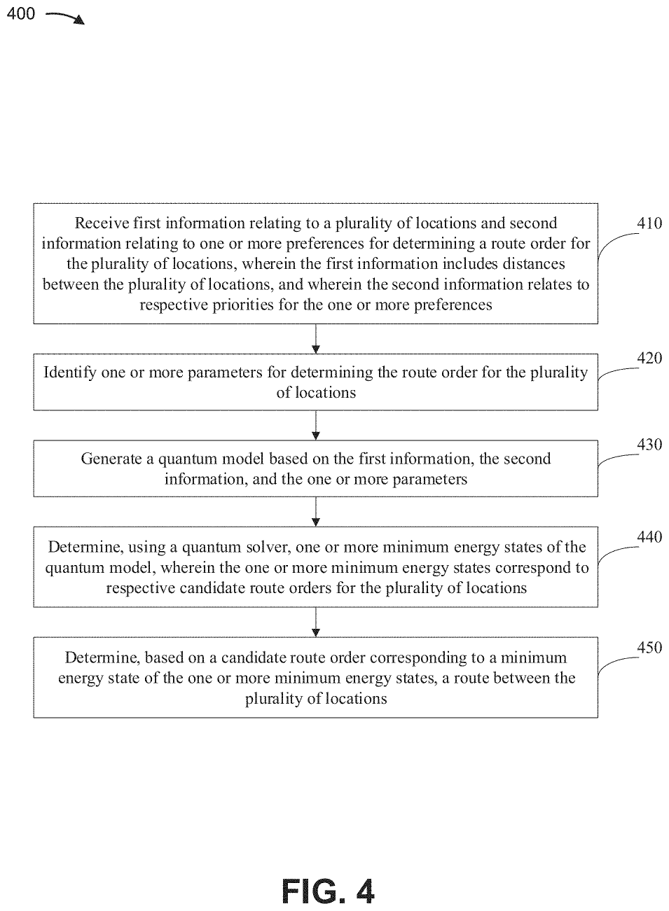

FIG. 4 is a flowchart of an example process 400 for determining a route order for locations. In some implementations, one or more process blocks of FIG. 4 may be performed by a route platform (e.g., route platform 220). In some implementations, one or more process blocks of FIG. 4 may be performed by another device or a group of devices separate from or including the route platform, such as a user device (e.g., user device 210), or the like.

As shown in FIG. 4, process 400 may include receiving first information relating to a plurality of locations and second information relating to one or more preferences for determining a route order for the plurality of locations, wherein the first information includes distances between the plurality of locations, and wherein the second information relates to respective priorities for the one or more preferences (block 410). For example, the route platform (e.g., using computing resource 225, processor 320, memory 330, storage component 340, input component 350, communication interface 370, and/or the like) may receive first information relating to a plurality of locations and second information relating to one or more preferences for determining a route order for the plurality of locations, as described above. In some implementations, the first information includes distances between the plurality of locations. In some implementations, the second information relates to respective priorities for the one or more preferences.

As further shown in FIG. 4, process 400 may include identifying one or more parameters for determining the route order for the plurality of locations (block 420). For example, the route platform (e.g., using computing resource 225, processor 320, memory 330, storage component 340, and/or the like) may identify one or more parameters for determining the route order for the plurality of locations, as described above.

As further shown in FIG. 4, process 400 may include generating a quantum model based on the first information, the second information, and the one or more parameters (block 430). For example, the route platform (e.g., using computing resource 225, processor 320, memory 330, storage component 340, and/or the like) may generate a quantum model based on the first information, the second information, and the one or more parameters, as described above.

As further shown in FIG. 4, process 400 may include determining, using a quantum solver, one or more minimum energy states of the quantum model, wherein the one or more minimum energy states correspond to respective candidate route orders for the plurality of locations (block 440). For example, the route platform (e.g., using computing resource 225, processor 320, memory 330, storage component 340, input component 350, output component 360, communication interface 370, and/or the like) may determine, using a quantum solver, one or more minimum energy states of the quantum model, as described above. In some implementations, the one or more minimum energy states correspond to respective candidate route orders for the plurality of locations.

As further shown in FIG. 4, process 400 may include determining, based on a candidate route order corresponding to a minimum energy state of the one or more minimum energy states, a route between the plurality of locations (block 450). For example, the route platform (e.g., using computing resource 225, processor 320, memory 330, storage component 340, input component 350, output component 360, communication interface 370, and/or the like) may determine, based on a candidate route order corresponding to a minimum energy state of the one or more minimum energy states, a route between the plurality of locations, as described above.

Process 400 may include additional implementations, such as any single implementation or any combination of implementations described below and/or in connection with one or more other processes described elsewhere herein.

In a first implementation, determining the route comprises providing, via an application programming interface, the candidate route order corresponding to the minimum energy state, to a shortest path solver, and determining, using the shortest path solver, the route between the plurality of locations. In a second implementation, alone or in combination with the first implementation, process 400 further comprises receiving valuation data relating to products that are to be delivered to the plurality of locations, and the quantum model is generated further based on the valuation data.

In a third implementation, alone or in combination with one or more of the first and second implementations, generating the quantum model comprises generating a QUBO of the first information based on the second information and the one or more parameters, and converting the QUBO to a matrix. In a fourth implementation, alone or in combination with one or more of the first through third implementations, the plurality of locations are delivery locations and the route is a delivery route.

In a fifth implementation, alone or in combination with one or more of the first through fourth implementations, the one or more parameters include at least one of a parameter specifying that each location, of the plurality of locations, is to be included in the route order only once, or a parameter specifying that each location, of the plurality of locations, is to be included in the route order. In a sixth implementation, alone or in combination with one or more of the first through fifth implementations, the one or more preferences relate to maximizing a valuation associated with the route order, minimizing a distance associated with the route order, minimizing a travel time associated with the route order, or minimizing a cost associated with the route order.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

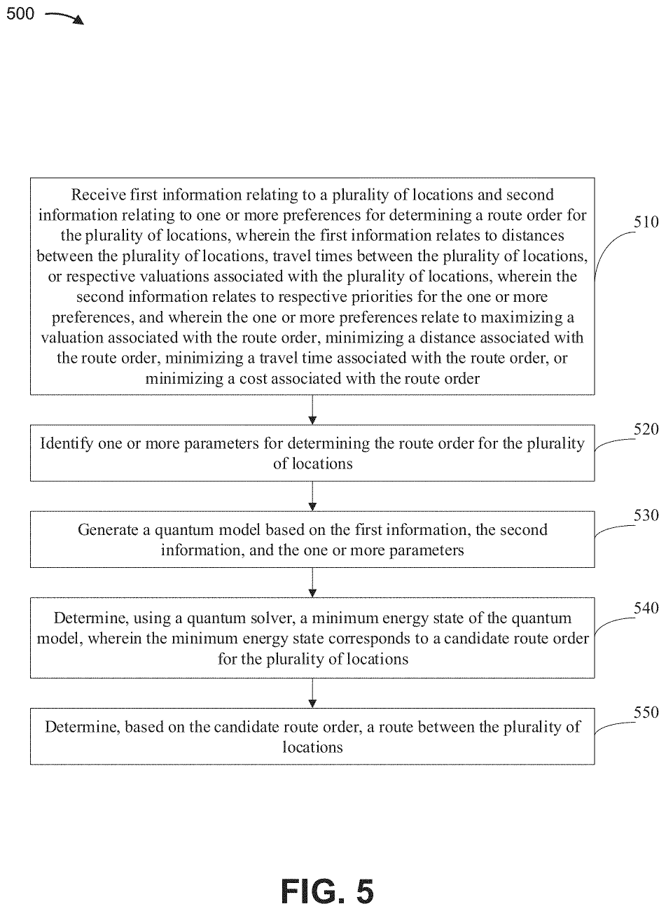

FIG. 5 is a flowchart of an example process 500 for determining a route order for locations. In some implementations, one or more process blocks of FIG. 5 may be performed by a route platform (e.g., route platform 220). In some implementations, one or more process blocks of FIG. 5 may be performed by another device or a group of devices separate from or including the route platform, such as a user device (e.g., user device 210), or the like.

As shown in FIG. 5, process 500 may include receiving first information relating to a plurality of locations and second information relating to one or more preferences for determining a route order for the plurality of locations, wherein the first information relates to distances between the plurality of locations, travel times between the plurality of locations, or respective valuations associated with the plurality of locations, wherein the second information relates to respective priorities for the one or more preferences, and wherein the one or more preferences relate to maximizing a valuation associated with the route order, minimizing a distance associated with the route order, minimizing a travel time associated with the route order, or minimizing a cost associated with the route order (block 510). For example, the route platform (e.g., using computing resource 225, processor 320, memory 330, storage component 340, input component 350, communication interface 370, and/or the like) may receive first information relating to a plurality of locations and second information relating to one or more preferences for determining a route order for the plurality of locations, as described above. In some implementations, the first information relates to distances between the plurality of locations, travel times between the plurality of locations, or respective valuations associated with the plurality of locations. In some implementations, the second information relates to respective priorities for the one or more preferences. In some implementations, the one or more preferences relate to maximizing a valuation associated with the route order, minimizing a distance associated with the route order, minimizing a travel time associated with the route order, or minimizing a cost associated with the route order.

As further shown in FIG. 5, process 500 may include identifying one or more parameters for determining the route order for the plurality of locations (block 520). For example, the route platform (e.g., using computing resource 225, processor 320, memory 330, storage component 340, and/or the like) may identify one or more parameters for determining the route order for the plurality of locations, as described above.

As further shown in FIG. 5, process 500 may include generating a quantum model based on the first information, the second information, and the one or more parameters (block 530). For example, the route platform (e.g., using computing resource 225, processor 320, memory 330, storage component 340, and/or the like) may generate a quantum model based on the first information, the second information, and the one or more parameters, as described above.

As further shown in FIG. 5, process 500 may include determining, using a quantum solver, a minimum energy state of the quantum model, wherein the minimum energy state corresponds to a candidate route order for the plurality of locations (block 540). For example, the route platform (e.g., using computing resource 225, processor 320, memory 330, storage component 340, input component 350, output component 360, communication interface 370, and/or the like) may determine, using a quantum solver, a minimum energy state of the quantum model, as described above. In some implementations, the minimum energy state corresponds to a candidate route order for the plurality of locations.

As further shown in FIG. 5, process 500 may include determining, based on the candidate route order, a route between the plurality of locations (block 550). For example, the route platform (e.g., using processor 320, memory 330, storage component 340, input component 350, output component 360, communication interface 370, and/or the like) may determine, based on the candidate route order, a route between the plurality of locations, as described above.

Process 500 may include additional implementations, such as any single implementation or any combination of implementations described below and/or in connection with one or more other processes described elsewhere herein.

In a first implementation, determining the minimum energy state of the quantum model comprises providing, via an application programming interface, the quantum model to the quantum solver, and determining, using the quantum solver, the minimum energy state of the quantum model. In a second implementation, alone or in combination with the first implementation, process 600 further comprises generating, for display in a user interface, a visualization of the route between the plurality of locations.

In a third implementation, alone or in combination with one or more of the first and second implementations, the plurality of locations are delivery locations and a valuation associated with a delivery location relates to a value of cargo to be delivered to the delivery location. In a fourth implementation, alone or in combination with one or more of the first through third implementations, generating the quantum model comprises generating a QUBO of the first information based on the second information and the one or more parameters, and converting the QUBO to a matrix.

In a fifth implementation, alone or in combination with one or more of the first through fourth implementations, the one or more parameters include at least one of a parameter specifying that each location, of the plurality of locations, is to be included in the route order only once, or a parameter specifying that each location, of the plurality of locations, is to be included in the route order. In a sixth implementation, alone or in combination with one or more of the first through fifth implementations, a priority for a preference relates to a ranking for the preference or a score for the preference.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

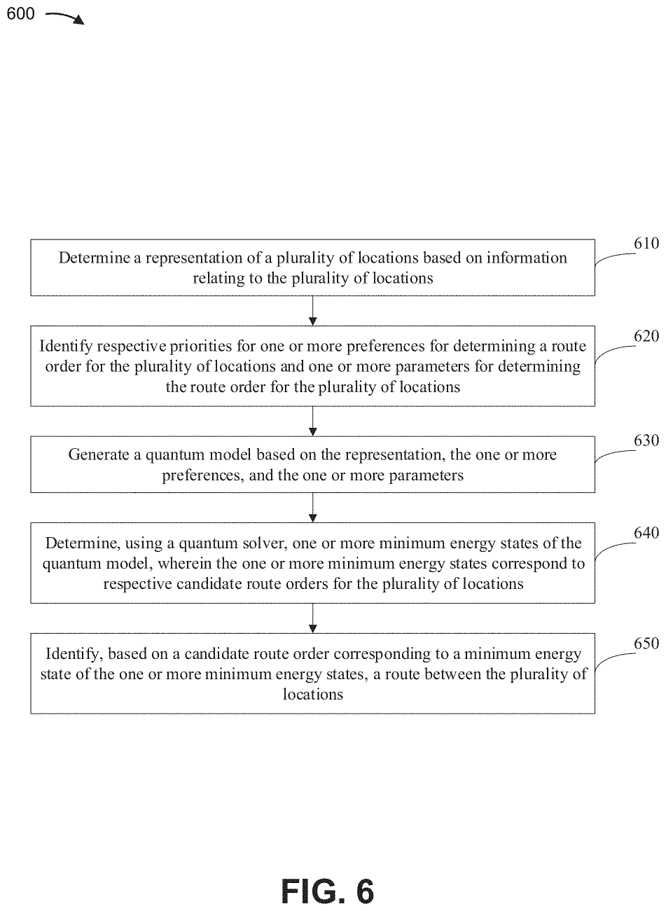

FIG. 6 is a flowchart of an example process 600 for determining a route order for locations. In some implementations, one or more process blocks of FIG. 6 may be performed by a route platform (e.g., route platform 220). In some implementations, one or more process blocks of FIG. 6 may be performed by another device or a group of devices separate from or including the route platform, such as a user device (e.g., user device 210), or the like.

As shown in FIG. 6, process 600 may include determining a representation of a plurality of locations based on information relating to the plurality of locations (block 610). For example, the route platform (e.g., using computing resource 225, processor 320, memory 330, storage component 340, and/or the like) may determine a representation of a plurality of locations based on information relating to the plurality of locations, as described above.

As further shown in FIG. 6, process 600 may include identifying respective priorities for one or more preferences for determining a route order for the plurality of locations and one or more parameters for determining the route order for the plurality of locations (block 620). For example, the route platform (e.g., using computing resource 225, processor 320, memory 330, storage component 340, and/or the like) may identify respective priorities for one or more preferences for determining a route order for the plurality of locations and one or more parameters for determining the route order for the plurality of locations, as described above.

As further shown in FIG. 6, process 600 may include generating a quantum model based on the representation, the one or more preferences, and the one or more parameters (block 630). For example, the route platform (e.g., using computing resource 225, processor 320, memory 330, storage component 340, and/or the like) may generate a quantum model based on the representation, the one or more preferences, and the one or more parameters, as described above.

As further shown in FIG. 6, process 600 may include determining, using a quantum solver, one or more minimum energy states of the quantum model, wherein the one or more minimum energy states correspond to respective candidate route orders for the plurality of locations (block 640). For example, the route platform (e.g., using computing resource 225, processor 320, memory 330, storage component 340, input component 350, output component 360, communication interface 370, and/or the like) may determine, using a quantum solver, one or more minimum energy states of the quantum model, as described above. In some implementations, the one or more minimum energy states correspond to respective candidate route orders for the plurality of locations.

As further shown in FIG. 6, process 600 may include identifying, based on a candidate route order corresponding to a minimum energy state of the one or more minimum energy states, a route between the plurality of locations (block 650). For example, the route platform (e.g., using computing resource 225, processor 320, memory 330, storage component 340, input component 350, output component 360, communication interface 370, and/or the like) may identify, based on a candidate route order corresponding to a minimum energy state of the one or more minimum energy states, a route between the plurality of locations, as described above.

Process 600 may include additional implementations, such as any single implementation or any combination of implementations described below and/or in connection with one or more other processes described elsewhere herein.

In a first implementation, the representation is a matrix or a graph. In a second implementation, alone or in combination with the first implementation, the information relates to distances between the plurality of locations, travel times between the plurality of locations, or respective valuations associated with the plurality of locations. In a third implementation, alone or in combination with one or more of the first and second implementations, the one or more preferences relate to maximizing a valuation associated with the route order, minimizing a distance associated with the route order, minimizing a travel time associated with the route order, or minimizing a cost associated with the route order.

In a fourth implementation, alone or in combination with one or more of the first through third implementations, the one or more parameters include at least one of a parameter specifying that each location, of the plurality of locations, is to be included in the route order only once, or a parameter specifying that each location, of the plurality of locations, is to be included in the route order. In a fifth implementation, alone or in combination with one or more of the first through fourth implementations, process 600 further comprises determining directions associated with the route between the plurality of locations, and providing, via a user interface, the directions.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Certain user interfaces have been described herein. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, and/or the like). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, first information relating to a plurality of locations and second information relating to one or more preferences for determining a route order for the plurality of locations,
wherein the first information includes distances between the plurality of locations,
wherein the second information relates to respective priorities for the one or more preferences;
identifying, by the device, one or more parameters for determining the route order for the plurality of locations;
generating, by the device, a quantum model based on the first information, the second information, and the one or more parameters;
determining, by the device and using a quantum solver, one or more minimum energy states of the quantum model,
wherein the one or more minimum energy states correspond to respective candidate route orders for the plurality of locations; and
determining, by the device and based on a candidate route order corresponding to a minimum energy state of the one or more minimum energy states, a route between the plurality of locations.

2. The method of claim 1, wherein determining the route comprises:
providing, via an application programming interface, the candidate route order corresponding to the minimum energy state, to a shortest path solver; and
determining, using the shortest path solver, the route between the plurality of locations.

3. The method of claim 1, further comprising:
receiving valuation data relating to products that are to be delivered to the plurality of locations,
wherein the quantum model is generated further based on the valuation data.

4. The method of claim 1, wherein generating the quantum model comprises:
generating a quadratic unconstrained binary optimization (QUBO) of the first information based on the second information and the one or more parameters; and
converting the QUBO to a matrix.

5. The method of claim 1, wherein the plurality of locations are delivery locations and the route is a delivery route.

6. The method of claim 1, wherein the one or more parameters include at least one of:
a parameter specifying that each location, of the plurality of locations, is to be included in the route order only once, or
a parameter specifying that each location, of the plurality of locations, is to be included in the route order.

7. The method of claim 1, wherein the one or more preferences relate to maximizing a valuation associated with the route order, minimizing a distance associated with the route order, minimizing a travel time associated with the route order, or minimizing a cost associated with the route order.

8. A device, comprising:
one or more memories; and
one or more processors communicatively coupled to the one or more memories, to:
receive first information relating to a plurality of locations and second information relating to one or more preferences for determining a route order for the plurality of locations,
wherein the first information relates to distances between the plurality of locations, travel times between the plurality of locations, or respective valuations associated with the plurality of locations,
wherein the second information relates to respective priorities for the one or more preferences,
wherein the one or more preferences relate to maximizing a valuation associated with the route order, minimizing a distance associated with the route order, minimizing a travel time associated with the route order, or minimizing a cost associated with the route order;
identify one or more parameters for determining the route order for the plurality of locations;
generate a quantum model based on the first information, the second information, and the one or more parameters;
determine, using a quantum solver, a minimum energy state of the quantum model,
wherein the minimum energy state corresponds to a candidate route order for the plurality of locations; and
determine, based on the candidate route order, a route between the plurality of locations.

9. The device of claim 8, wherein the one or more processors, when determining the minimum energy state of the quantum model, are to:
provide, via an application programming interface, the quantum model to the quantum solver; and
determine, using the quantum solver, the minimum energy state of the quantum model.

10. The device of claim 8, wherein the one or more processors are further to:
generate, for display in a user interface, a visualization of the route between the plurality of locations.

11. The device of claim 8, wherein the plurality of locations are delivery locations and a valuation associated with a delivery location relates to a value of cargo to be delivered to the delivery location.

12. The device of claim 8, wherein the one or more processors, when generating the quantum model, are to:
generate a quadratic unconstrained binary optimization (QUBO) of the first information based on the second information and the one or more parameters; and
convert the QUBO to a matrix.

13. The device of claim 8, wherein the one or more parameters include at least one of:
a parameter specifying that each location, of the plurality of locations, is to be included in the route order only once, or
a parameter specifying that each location, of the plurality of locations, is to be included in the route order.

14. The device of claim 8, wherein a priority for a preference relates to a ranking for the preference or a score for the preference.

15. A non-transitory computer-readable medium storing instructions, the instructions comprising:
one or more instructions that, when executed by one or more processors, cause the one or more processors to:
determine a representation of a plurality of locations based on information relating to the plurality of locations;
identify respective priorities for one or more preferences for determining a route order for the plurality of locations and one or more parameters for determining the route order for the plurality of locations;
generate a quantum model based on the representation, the one or more preferences, and the one or more parameters;
determine, using a quantum solver, one or more minimum energy states of the quantum model,
wherein the one or more minimum energy states correspond to respective candidate route orders for the plurality of locations; and
identify, based on a candidate route order corresponding to a minimum energy state of the one or more minimum energy states, a route between the plurality of locations.

16. The non-transitory computer-readable medium of claim 15, wherein the representation is a matrix or a graph.

17. The non-transitory computer-readable medium of claim 15, wherein the information relates to distances between the plurality of locations, travel times between the plurality of locations, or respective valuations associated with the plurality of locations.

18. The non-transitory computer-readable medium of claim 15, wherein the one or more preferences relate to maximizing a valuation associated with the route order, minimizing a distance associated with the route order, minimizing a travel time associated with the route order, or minimizing a cost associated with the route order.

19. The non-transitory computer-readable medium of claim 15, wherein the one or more parameters include at least one of:
a parameter specifying that each location, of the plurality of locations, is to be included in the route order only once, or
a parameter specifying that each location, of the plurality of locations, is to be included in the route order.

20. The non-transitory computer-readable medium of claim 15, wherein the one or more instructions, when executed by the one or more processors, further cause the one or more processors to:
determine directions associated with the route between the plurality of locations; and
provide, via a user interface, the directions.
